(19) United States
(12) Patent Application Publication
(10) Pub. No.: US 2013/0103760 A1
(43) Pub. Date: Apr. 25, 2013

(54) LOCATION-SENSITIVE VIRTUAL IDENTITY SYSTEM, APPARATUS, METHOD AND COMPUTER-READABLE MEDIUM

(71) Applicants: Robert K. Golding, Toronto, CA (US); John D. Curtin, Toronto (CA); Trevor James R. Haldenby, Toronto (CA); Benjamin James Pullia, Toronto (CA); Scott Thomas Cairns, Ancaster (CA)

(72) Inventors: Robert K. Golding, Toronto, CA (US); John D. Curtin, Toronto (CA); Trevor James R. Haldenby, Toronto (CA); Benjamin James Pullia, Toronto (CA); Scott Thomas Cairns, Ancaster (CA)

(21) Appl. No.: 13/443,545

(22) Filed: Apr. 10, 2012

Related U.S. Application Data
(60) Provisional application No. 61/474,051, filed on Apr. 11, 2011.

(51) Int. Cl. H04L 29/08

(52) U.S. Cl. CPC H04L 67/22
USPC 709/204

(57) ABSTRACT

Disclosed herein are different embodiments of a location-sensitive virtual identity system, apparatus, method and computer-readable medium.

### CROSS-REFERENCE TO RELATED APPLICATIONS

The present application claims priority from U.S. Provisional Application Ser. No. 61/474,051 filed Apr. 11, 2011, the entire contents of which are hereby incorporated herein by reference.

### FIELD OF THE DISCLOSURE

The present disclosure relates to virtual identities, and in particular, to a location-sensitive virtual identity system, apparatus, method and computer-readable medium.

### BACKGROUND OF THE INVENTION

Different electronic devices and systems have been proposed and marketed to allow a user of such devices/systems to control or otherwise affect a condition of a virtual character or pet by completing certain tasks or responding to certain cues. For example, virtual pet systems have been popularized for the purpose of teaching children, in some instances, the merits of caring for their virtual pet in ensuring the pet's wellbeing, be it via a happiness or health rating that varies as a function of the user completing certain timely virtual actions such as feeding, grooming, and other such caretaking actions for their pet.

Dedicated devices provided for the implementation and control of these virtual realities generally include some form of graphical user interface that depicts the character in various states and provides various buttons or keys to select and implement various actions in respect of the virtual character, these actions being effectively processed by a processor of the device and stored in memory allowing the virtual care of the character to evolve over time. Similar systems have been developed to be implemented over the Internet, e.g., via an Internet website or the like, using a personal computer. Alternatively, some websites provide virtual characters that users can download to their computers to “care for” locally, or again, allow for certain elements of the virtual world created in respect of these characters to be downloaded to the local device. In such cases, the device used to interact with the virtual character will generally include some form of communication device, for example, for accessing various features online via an Internet Website or the like.

U.S. Patent Application No. 2007/0143679 provides an example of an interactive virtual character device in which regional weather broadcasts are received by the device over a wireless data network. The user then issues commands to select articles of clothing to be worn by the virtual character and the processor causes the virtual character to smile if the user-selected clothing is suitable for the broadcasted weather and to frown if the selections are not suitable.

U.S. Patent Application No. 2011/0070935 provides another example, in which a traveling virtual pet game simulates a pet traveling between various geographic locations. As the pet travels, different users interact with the virtual pet to aid the pet in acquiring traits associated with the geographic regions in which it travels and to observe traits that the pet has previously acquired.

While the above examples exploit some of the features now made available by recent developments in communication technology, such as by extracting regionally broadcast data to enhance the user's interactive play or by allowing a virtual pet to be shared geographically over a data network to acquire and accumulate geographically-defined traits, much remains to be explored in leveraging and fully exploiting the benefits and features of recent technologies in the fields of wireless communications, social networks, and the like, to provide an enhanced or improved user experience with respect to the management, deployment and/or implementation of a virtual identity, be it for the purpose of entertainment or education, to name a few. Therefore, there remains a need for new and innovative virtual identity systems and methods that take advantage of recent technological progress in providing new or alternative end user experiences with respect to the implementation and/or management of virtual identities, and user interactions therewith.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the invention is to provide a location-sensitive virtual identity system, apparatus, method and computer-readable medium. In accordance with an embodiment of the invention, there is provided a method for adjusting one or more attributes of a virtual identity associated with a user of a portable computing device, the method comprising: successively identifying portable computing device locations; accessing a respective location-sensitive attribute adjustment for each of said successively identified locations; and successively adjusting the one or more attributes as a function of each said respective location-sensitive attribute adjustment.

In accordance with another embodiment of the invention, there is provided a method for dynamically adjusting attributes of a virtual identity associated with a user of a portable computing device, the method comprising the steps of: identifying a location of the portable computing device by location type; accessing one or more location-sensitive attribute adjustments associated with said location type; and adjusting the attributes as a function of said one or more location-sensitive attribute adjustments.

In accordance with another embodiment of the invention, there is provided a system for managing location-sensitive attributes associated with a virtual identity implemented on or associated with a user's portable computing device, the system comprising: a data storage device for storing predefined location-sensitive attribute adjustments in association with predefined locations and/or location types; and a network communication device communicatively linkable to the user's portable computing device to access successive locations of the user's portable computing device, and operatively coupled to said data storage device to access respective location-sensitive attribute adjustments corresponding to each of said successive locations, and/or a location type thereof, and affect corresponding adjustments to the location-sensitive attributes of the virtual identity.

In accordance with another embodiment of the invention, there is provided a method for adjusting one or more attributes of a virtual identity implemented on a portable computing device, the method comprising the steps of: identifying a location of the portable computing device; accessing a location-sensitive attribute adjustment associated with the location; adjusting the one or more attributes as a function of said location-sensitive attribute adjustment; identifying a subsequent location of the portable computing device; accessing a subsequent location-sensitive attribute adjustment associated with the subsequent location; and adjusting the one or more attributes as a function of said subsequent location-sensitive attribute adjustment.

In accordance with another embodiment of the invention, there is provided a method for adjusting one or more attributes of a virtual identity implemented on a portable computing device, the method comprising the steps of: successively identifying portable computing device locations; accessing a respective location-sensitive attribute adjustment for each of said successively identified locations; and successively adjusting the one or more attributes as a function of each said respective location-sensitive attribute adjustment.

In accordance with another embodiment of the invention, there is provided a method for dynamically adjusting attributes of a virtual identity implemented on a portable computer, the method comprising the steps of: identifying a location of the portable computing device by location type; accessing one or more location-sensitive attribute adjustments associated with said location type; and adjusting the attributes as a function of said one or more location-sensitive attribute adjustments.

In accordance with another embodiment of the invention, the above methods are automatically implemented by a processor of the portable computing device and/or of one or more networked computing devices communicatively linked thereto.

In accordance with another embodiment of the invention, there is provided a computer-readable medium having statements and instructions stored thereon for implementation by a processor of a portable computing device to dynamically adjust one or more attributes of a virtual identity implemented on the portable computing device by implementing the steps of the above-defined methods.

In accordance with another embodiment of the invention there is provided a system for managing location-sensitive attributes associated with a virtual identity implemented on a user's portable computing device, the system comprising: a data storage device for storing predefined location-sensitive attribute adjustments in association with predefined locations; and a network communication device communicatively linkable to the user's portable computing device to access successive locations of the user's portable computing device, and operatively coupled to said data storage device to access respective location-sensitive attribute adjustments corresponding to each of said successive locations and affect corresponding adjustments to the location-sensitive attributes of the virtual identity.

In accordance with another embodiment of the invention, there is provided a system for managing attributes associated with a virtual identity implemented on a user's portable computing device, the system comprising: a data storage device for storing predefined location-sensitive attribute adjustments in association with predefined location types; and a network communication device communicatively linkable to the user's portable computing device and operatively coupled to the data storage device, said network communication device being configured to access a location of the user's portable computing device, identify a given location type to be associated therewith, and access a given location-sensitive attribute adjustment corresponding to said given location type to affect a corresponding adjustment to the attributes of the virtual identity.

Other aims, objects, advantages and features of the invention will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a system level diagram of a virtual identity system, in accordance with one embodiment of the invention;

FIGS. 2 to 5 are screenshots of an exemplary graphical user interface for a virtual identity application implemented on a portable computing device, in accordance with one embodiment of the invention;

FIG. 6 is a flow diagram of an exemplary location check-in process implemented with respect to a virtual identity system, in accordance with one embodiment of the invention;

FIG. 7 is a flow diagram of an exemplary inventory/store process implemented with respect to a virtual identity system, in accordance with one embodiment of the invention; and

FIG. 8 is a diagrammatic representation of a location-sensitive virtual identity device, in accordance with one embodiment of the invention.

### DETAILED DESCRIPTION OF THE PREFERRED EMBODIMENTS

It should be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical or electrical connections or couplings. Furthermore, and as described in subsequent paragraphs, the specific mechanical or electrical configurations illustrated in the drawings are intended to exemplify embodiments of the disclosure. However, other alternative mechanical or electrical configurations are possible which are considered to be within the teachings of the instant disclosure. Furthermore, unless otherwise indicated, the term “or” is to be considered inclusive.

The term “virtual identity” is used herein to define a virtual character, entity, being, pet, plant, flower, avatar and/or personification; and/or a virtual representation of a user manifested as a virtual character, being, pet, plant, flower, avatar or personification; or again a virtual entity represented by various visible, audible, textile, physical and/or other such sensory cues such as text, lights, graphics, sounds, vibrations, colors, shapes, physical configurations and the like. In general, a virtual identity will be associated with a user of the system making regular use of a portable computing device, the user and/or device being recognizable by the herein-described embodiments. In some exemplary embodiments, as will be described in greater details below, the virtual identity is implemented on and/or by the portable computing device of the user. In such embodiments, a virtual identity may be represented graphically on a graphical user interface of the user's portable device as a creature, animal, human, plant, flower, character or other such virtual figure, and/or as a series of traits, attributes and data representative of the virtual identity over time. In some exemplary embodiments, the virtual identity is also or alternatively implemented on or by a distinct user device effectively associated through the system with the user and/or his portable computing device. In some exemplary embodiments, the virtual identity is also or alternatively maintained by a remote computing platform such as a system server of the like communicatively accessible by the user, whereby the identity may be rendered for the user upon accessing the remote computing platform. Various combinations of the above-described examples are also contemplated herein, as will be readily apparent to the person of ordinary skill in the art upon reading the following description. In some embodiments, the virtual identity may be a direct and/or fictionalized virtual manifestation of the user and its activities, and/or represent a purely fictional manifestation of a virtual entity as defined within a virtual world or within the context of a virtual network of such virtual identities, while nonetheless affected by the user's actions/inactions and/or interactions therewith.

The term “attribute” is used herein to define a characteristic of the virtual identity that can be varied over time as a function of user actions and interactions recorded and/or otherwise identified in relation to the virtual identity. Examples of attributes may include, but are not limited to, a health attribute, a fitness attribute, a social attribute, an intelligence attribute, a knowledge attribute, a spirituality attribute, a hunger attribute, a happiness attribute, and the like. In general, attributes may be represented by a variable scale or value that moves up or down based on user actions (or inactions), and that can, in some examples, be affected or otherwise interrelated with other attributes. As will be appreciated by the skilled artisan, other attribute variability measures may also or alternatively be implemented, which may include, for example, color variations to represent mood or humor (e.g., a happy attribute may vary from dark to bright when a user frequents locations or location types recognized as increasing a user's general happiness, or a mood attribute may vary through different colors such as identified, for example, by conventional mood items such as mood rings and the like, when a user frequents a stressful establishment such as a hospital as compared to a relaxing establishment such as spa, to name a few). In some embodiments, attributes may be effective representations or personifications of the user, whereas in other embodiments, such attributes may rather or further include imaginary and/or fantastical attributes creatively associated with and adjusted as a function of the user's actions/inactions. While some of the attributes in a given embodiment may be exclusively or selectively affected by location-insensitive actions, such as virtual feeding, attention, grooming, and the like, as commonly implemented in traditional virtual pet systems, for example, the following will focus more specifically on the provision, adjustment and maintenance of location-sensitive attributes, whereby such attributes are cumulatively adjusted, at least in part, as a function of the locations frequented by the user while carrying a portable computing device implementing and/or associated directly or indirectly with the virtual identity, for example (e.g., locations to which the virtual identity is effectively exposed). Accordingly, the overall attribute allocations associated with a given virtual identity, in accordance with different embodiments of the invention herein described, are at least in part affected by the specific locations frequented by the user carrying the portable computing device on which the virtual identity is implemented or with which the virtual identity is directly or indirectly associated, for example, through the implementation of location-sensitive and/or location-type specific attribute adjustments, to name a few examples.

The term “trait” is used herein to define an original or acquired characteristic of the virtual identity generally represented by a value, token or object selectively or automatically associated with the virtual identity to represent, for example, a quality, accomplishment or nature of the identity. In some embodiments, traits may be acquired, learned and/or earned by the virtual identity upon completion of certain tasks or again upon frequenting certain recognized establishments or locations. For example, awards, badges or items may be associated with a virtual identity upon completing certain tasks, or again upon the user frequenting a certain location a number of times or beyond a predetermined frequency. The person of ordinary skill in the art will appreciate distinctions between traits and attributes as defined herein to represent different types of characteristics, whereby attributes are associated more specifically with characteristics traditionally associated with a dynamically variable “wellbeing” of the virtual identity, (e.g., attributes that may move up or down as a function of user action/inaction) as compared to traits which are more specifically associated with a virtual quality, acquisition and/or accomplishment of the virtual identity that can be accumulated, inventoried and/or otherwise acquired.

The following describes different non-limiting embodiments and examples of a location-sensitive virtual identity system, method, device and computer-readable medium, wherein a virtual identity as defined above and exemplified below resides or is otherwise rendered or implemented by, on or in direct or indirect association with a portable computing device of a user. Upon the portable device being used, operated and/or otherwise carried to or in the vicinity of a recognizable location and/or location type, such as a geographical location, a venue, an activity, an establishment and the like, location-sensitive attributes of the virtual identity associated with or specific to such the location and/or location type may be adjusted, thereby representing a cumulative effect on the virtual identity of the user frequenting (or not frequenting) certain locations and/or location types. Accordingly, the virtual identity's “wellbeing,” be it determined as a function of realistic or humanistic wellbeing attributes and/or as a function of surrealistic, fantastical, comical, social or otherwise defined wellbeing attributes, can be actively and dynamically adjusted as a function of the user's identified/recognized activities. Furthermore, by incorporating, cross-referencing and/or associating a user's related virtual identity within a social network and/or role playing game (RPG) environment or platform, further interactivity with and between virtual identities can be implemented to enhance the user experience.

As will be appreciated by the skilled artisan, while the below described systems and methods may be utilized for the purpose of entertainment or divertissement, they may also provide an educational tool for the purpose of sensitizing users to the potential effects and repercussions of their actions. For example, providing a virtual identity system, as described herein, for the purpose of educating or sensitizing users with respect to their health, fitness, green initiatives, activism or the like may provide an entertaining approach to such education or sensitization that may be more readily absorbed and respected than other more conventional means. These and other such considerations are thus considered to fall within the scope of the present disclosure.

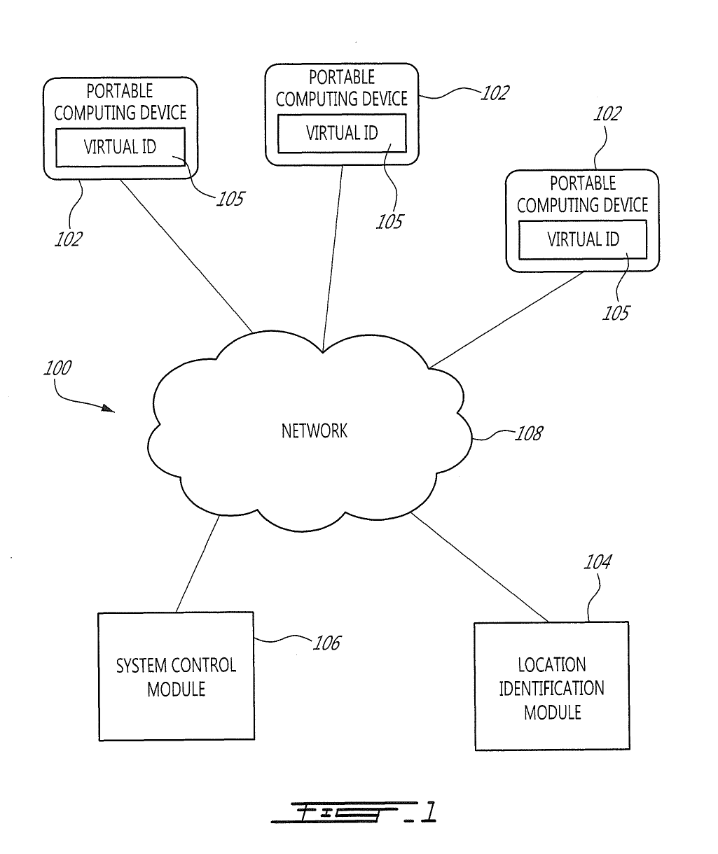

Referring now to FIG. 1, and in accordance with one embodiment of the invention, a virtual identity system, generally referred to using the numeral 100, will now be described. In this embodiment, the system 100 generally comprises one or more location-sensitive portable computing devices 102 on, by or in direct or indirect association with which respective users implement respective virtual identities 105, a location identification module 104 adapted to identify a location of the one or more portable computing devices 102, and a system control module 106 for controlling, managing and/or facilitating implementation of the respective identities 105 and/or implementation of location-sensitive identity attribute adjustments associated with respective virtual identities implemented thereon.

For illustrative purposes, the embodiment of FIG. 1 depicts each virtual identity 105 as residing on a respective portable computing device 102. As will be described in greater detail below with reference to different exemplary embodiments, and as introduced above, the system 100 may allow for a virtual identity to be implemented or rendered on or by the user's portable computing device, either locally and/or via communicative access to the system control module 106, location identification module 104, and/or other such network accessible computing platforms; and/or again locally, remotely or distributively implemented and/or rendered on or by a distinct user device directly or indirectly associated with the user's portable computing device.

For illustrative purposes, the embodiment of FIG. 1 is also depicted by distinct modules communicatively linkable via one or more data communication networks 108, such as the Internet or the like. It will, however, be appreciated that other embodiments, as described below, may include one or more integrated modules whereby, for example, various functions and/or features may be combined within a same integrated device, be it a self-contained portable-computing device including an integrated system control and location identification module, a combined system control and location identification module commonly implemented within a dedicated system server, or other such combinations and permutations as will be readily apparent to the person of ordinary skill in the art upon reference to the following non-limiting description of illustrative embodiments.

In this non-limiting example, which will focus on the implementation or rendering of the virtual identities 105 on respective portable computing devices 102, each portable computing device 102 will include one or more processors, one or more data storage devices and a user interface, which may include a graphical user interface such as a display screen and/or touchscreen display, a keyboard, button(s), scroll pads, ball or widget, and other such user interfaces allowing for user interactivity with the device. Each device will also include one or more communication devices, such as a wireless transceiver or the like for enabling data communications with the system control module (e.g., cellular, Wi-Fi, etc.), as well as a geo-positional location device, such as a GPS receiver or the like, to facilitate localization of the device for the purpose of enabling implementation of location-sensitive identity attribute adjustments as a function of the location of the portable computing device. As will be appreciated by the skilled artisan, while some embodiments contemplate the use of GPS data to facilitate implementation of location-sensitive identity attribute adjustments, other locational technologies may be utilized to provide a similar effect. For example, alternative and/or cooperative location identification technologies may include, but are not limited to: GPS, RFID tags, Bluetooth, Wi-Fi, bar code or QR code scanning, cellular triangulation, point of sale (e.g., bar code or QR code scanning at a given location such as a store, kiosk, ticket purchase or verification gate, etc.) and other such technologies as will be readily apparent to the person of ordinary skill in the art.

Accordingly, the provision of location-sensitive or location-type specific attribute adjustments may rely on different location identification technologies, and similarly, on different location characterizations. For example, in some embodiments, a location may be defined by a geographic location with which is associated a particular location-sensitive attribute adjustment, e.g., reaching the summit of a local peak or mountain registered with or otherwise identifiable by the system may positively affect a health and happiness attribute associated with a virtual identity implemented on or in direct or indirect association with a portable computing device at this location. In a same or alternative embodiment, attending a particular event recognizable by its geographic location or by scanning in the barcode or QR code of an associated ticket stub may, for example, impact a virtual identity's cultural or social attribute. Similarly, attending a given venue or establishment, such as a restaurant, movie theatre or concert hall may be identified by cross-referencing the geographical location of the user's device with a locational index of local establishments, or again by logging into the establishment's local data network or making a recognizable purchase at this location. In another example, the location may rather be associated with an activity, whereby participation in such activity, upon being recognized by the system, affects an attribute adjustment respective of this activity; e.g., participating in a white water rafting trip or attending a cultural walk through the downtown area of a historical village may both differently impact the user's virtual identity attributes upon the system automatically locating participation in such activity or upon the user logging in a location related to this activity, for example. These and other such examples will be readily apparent to the person of ordinary skill in the art to fall within the scope and nature of the present disclosure.

As will be appreciated by the person of ordinary skill in the art, in embodiments where the virtual identity is implemented by or on the portable computing devices 102, these devices may generally include portable devices having sufficient computing, communicative and locative functions to implement and/or render the features and operations of the virtual identity thereon, and enable implementation of location-sensitive attribute adjustments in relation thereto. Where the virtual identity is rather implemented remotely by a server of the system accessible by the portable communication device or other user devices, for example, or again where the virtual identity is rather implemented and/or rendered by or on a distinct user device, different device requirements will apply, as will be readily apparent to the person of ordinary skill in the art. Examples of portable computing devices may include, but are not limited to, dedicated portable computing devices designed and configured for the main purpose of implementing the virtual identity thereon; multipurpose or multiplatform portable computing/communication devices such as laptops, netbooks, tablets and other such generally internet-ready devices (e.g., via Wi-Fi, Bluetooth, LAN, etc.); cellular phones, smartphones (e.g., GPS enabled smart phones such as the iPhone, Android, BlackBerry, etc.) and other such handheld devices; and combinations thereof (e.g., laptop, netbook or tablet operatively coupled to a cellular phone or the like) suitable in delivering the combined functionalities exploited in implementing different embodiments of the invention herein described.

Still referring to FIG. 1, the network 108 can comprise different types and/or combinations of data communication infrastructures or systems that allow for various intercommunications between the devices 102, the control module 106 and the location identification module 104, and optionally, to distinct user devices (not shown) used in some embodiments to implement and/or render the virtual identity. For example, network 108 may represent different combinations of one or more of the following or portions thereof: the global data network commonly referred to as the Internet, cellular telecommunications networks, public switched telephone systems, cable or fiber-based television and data service networks, local-area networks (LANs), and personal-area networks (PANs) such as that defined by the well-known Bluetooth short-range wireless communication specification or other wireless specifications such as IEEE 802.11 and WIMAX. Furthermore, while the implementation of and interaction with the virtual identity system of FIG. 1 may be facilitated by the provision of wireless communications between the portable devices 102 and the rest of the system 100, the system may nonetheless be implemented via wired network connections, whereby a given portable computing device 102 may be wired to a communication network provided at a given location and achieve similar results as if otherwise wirelessly connected to the network 108, such as via a cellular, Wi-Fi or other such wireless connection. It will be further appreciated by the skilled artisan that various intermediaries may be interposed between the various elements of system 100 in establishing a network connection without departing from the general scope and nature of the present disclosure.

In accordance with one embodiment, the location identification module 104 of system 100 generally comprises a locative service server or the like, which receives as input a location of the user's portable device, for example, as acquired via an integrated GPS receiver, cellular triangulation, Wi-Fi or other such means as described herein, and cross-references this location with a list or database of system recognizable locations at or near the user's location. As will be appreciated by the skilled artisan, the portable computing device's location may be communicated directly to the location identification module by the computing device, or may be communicated indirectly thereto via the system control module, for example. Alternatively, the portable computing device may maintain its own location database, thus enabling integration of the location identification module within the portable computing device. This latter example may be particularly relevant in the implementation of a self-contained virtual identity device which may operate independently of external sources.

In one embodiment, the location identification module (e.g., locative service provider) may maintain an active and dynamic database of locations with which different location-sensitive identity attribute adjustments may be generated. In one example, the locative service provider may also provide access to the virtual identity system, whereby recognizable locations and associated attribute adjustments are compiled and maintained jointly, in which case the location identification module and system control module may be implemented by a same or shared system server, for example. In one such example, the combined network accessible platform or server is further configured to store and dynamically maintain the attributes associated with distinct virtual identities, for example, in the form of a user profile or the like. In such embodiments, the system server may be configured to receive the user's location from the user's portable computing device, identify an attribute adjustment to be associated therewith, and implement this attribute adjustment. The adjusted attribute(s) may then be communicated to, or otherwise retrieved by the user's portable computing device and/or other device associated with the user's profile and configured to render the virtual identity, such that the attributes so adjusted may be consumed by the user.

In another embodiment, the location identification module is implemented by a distinct service provider via a distinctly operated server. Examples of known locative service providers may include, but are not limited to Foursquare, Facebook Places, Google Places, Yelp and the like. In such embodiments, the system control module 106 may rather access the user's portable computing device location and implement appropriate application protocol interface (API) calls to the server(s) of one or more such locative service providers and access therefrom a list of recognizable locations in the user's vicinity. In doing so, the application control module 106 may then cross-reference these recognizable locations with its own listing of location-based attribute adjustments, for example, based on a recognizable establishment name at one of these locations (e.g., Starbucks, Museum, Sports Arena, Airport, etc.) or again as a function of a categorized location type associated with the recognizable locations. Similar considerations discussed above with respect to server initiated and/or managed identities may also be considered in this context.

In one embodiment, the virtual identity's location-sensitive attributes may be updated automatically upon the user frequenting one of the recognizable locations. In another embodiment, the system may rather request the user to confirm or check into a given location, for example, as described below with reference to the following examples, before implementing related attribute adjustments.

In accordance with different embodiments, the system control module 106 may be configured to implement different system-related operations, which may include, but are not limited to, maintaining a database of virtual identity users and their associated attributes, providing cross-referencing between recognizable locations and/or location types and associated location-sensitive attribute adjustments, providing social networking functions between users of the virtual identity system (e.g., directly and/or via distinct social network service providers such as Facebook, Twitter, Linkedln, Foursquare and the like), managing accounting information related to each user (e.g., in the context of a chargeable service or for the management of application purchases, downloads, licenses and/or updates), and other such system management function as will be readily apparent to the person of ordinary skill in the art.

It will be appreciated by the skilled artisan that additional system modules, servers and/or devices may be considered in the present context to provide similar results, for example, in enabling different system and network architectures and/or facilitating use of the system by users of portable computing devices having different networking capacities and/or capabilities (e.g., GPS enabled devices, cellular devices, Wi-Fi enabled devices, multiplatform devices, legacy devices, etc.). Furthermore, it will be appreciated that the above-described modules may represent self-standing devices, such as servers, networked computers or devices and the like, and comprising dedicated and/or shared data storage devices, communication devices/interfaces, processors and the like, or again be comprised within a multipurpose device or network having shared resources. These and other such considerations are therefore considered to fall with the scope and context of the present disclosure.

### EXAMPLES

Reference will now be made to the following non-limiting examples of illustrative embodiments.

### Example 1

The following provides an example of applicable location-sensitive attribute adjustments in respect of a virtual entity implemented on a portable computing device upon a user thereof frequenting locations as defined by the identified location types, in accordance with one embodiment of the invention. In this particular example, the location-sensitive attributes of the virtual identity include a social attribute, a health attribute, a culture attribute, a happy attribute, a food attribute and a smarts attribute. Each variable and location-sensitive attribute is defined by a similar valuation scale and adjustments thereto associated with respective ones of the location types are set to vary between −5 and 5. Accordingly, the predefined location-type specific attribute adjustments have for effect to automatically adjust one or more attributes of a given virtual identity upon a user thereof frequenting a given location of recognizable type, or again upon the user login-in the given location of recognizable type upon frequenting the location, for example.

| Category | Type | Social | Health | Culture | Happy | Food | Smarts |
|---|---|---|---|---|---|---|---|
| Arts & | Arcade | 2 | −2 | 2 | −2 | 0 | 0 |
| Entertainment | Art Gallery | 2 | 0 | 5 | −2 | 0 | 3 |
| | Billiards | 3 | 0 | 1 | −2 | −1 | 0 |
| | Bowling Alley | 3 | 0 | 1 | −2 | −1 | 0 |
| | Casino | 1 | −1 | −1 | 2 | 0 | −1 |
| | Comedy Club | 3 | 0 | 3 | −2 | −1 | −1 |
| | Gaming Cafe | 2 | −1 | 1 | −1 | −1 | 0 |
| | Internet Cafe | 2 | −1 | 2 | −1 | 0 | 1 |
| | Movie Theatre | 1 | −1 | 3 | −1 | −1 | 1 |
| | Museum | 2 | 0 | 5 | −2 | 0 | 3 |
| | Music Venue | 2 | 0 | 3 | −1 | 0 | 0 |
| | Other - Entertainment | 1 | 0 | 2 | −1 | 0 | 0 |
| | Perf. Arts - Concert Hall | 2 | 0 | 4 | −1 | 0 | 0 |
| | Perf. Arts - Dance Studio | 2 | 1 | 4 | −1 | 0 | 0 |
| | Perf. Arts - Opera House | 2 | 0 | 4 | −1 | 0 | 0 |
| | Perf. Arts - Theatre | 2 | 0 | 4 | −1 | 0 | 0 |
| | Racetrack | 2 | 0 | 2 | 1 | 0 | 0 |
| | Stadium | 3 | 0 | 3 | 0 | −2 | 0 |
| | Strip Club | 2 | −2 | −1 | −3 | 0 | 0 |
| | Theme Park | 3 | 0 | −1 | −3 | −2 | 0 |
| | Water Park | 3 | 0 | −1 | −3 | 0 | 0 |
| | Zoo/Aquarium | 2 | 0 | 1 | 0 | 0 | 1 |
| College & | Academic Building (Arts) | 2 | 0 | 4 | 1 | 0 | 2 |
| Education | Acad. Building (Comms) | 2 | 0 | 4 | 1 | 0 | 2 |
| | Acad. Building (Eng.) | 2 | 0 | 4 | 1 | 0 | 2 |
| | Acad. Building (History) | 2 | 0 | 4 | 1 | 0 | 2 |
| | Acad. Building (Math) | 2 | 0 | 2 | 1 | 0 | 3 |
| | Acad. Building (Science) | 2 | 0 | 2 | 1 | 0 | 3 |
| | Acad. Building | 2 | 0 | 2 | 1 | 0 | 3 |
| | (Technology) | | | | | | |
| | Admin Building | 0 | 0 | 0 | 3 | 0 | 0 |
| | Auditorium | 2 | 0 | 0 | 1 | 1 | 1 |
| | Bookstore | 0 | −1 | 2 | 0 | 0 | 2 |
| Food & Drink | Coffee Shop | 2 | 0 | 0 | 1 | −1 | 0 |
| | Pub | 3 | −2 | 0 | 2 | −2 | −1 |
| | Restaurant | 1 | 2 | 0 | 1 | −3 | 0 |

### Example 2

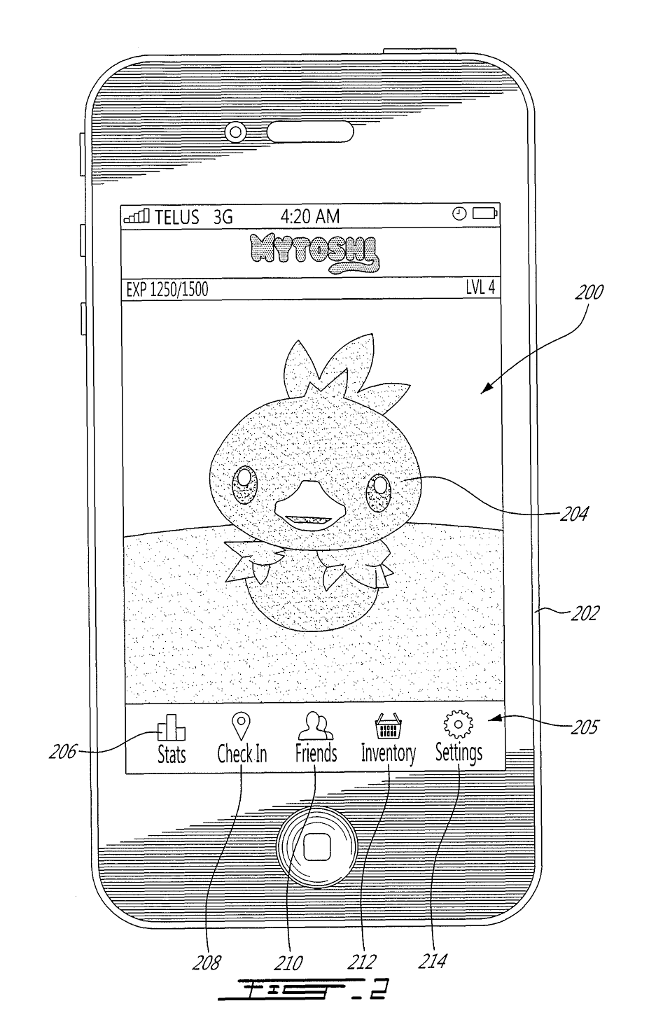

FIGS. 2 to 5 provide exemplary snapshots of a graphical user interface 200 of a portable computing device 202 implementing a virtual identity 204, in accordance with one embodiment of the invention. In this example, the portable computing device 202 consists of an iPhone having a touchscreen graphical user interface 200 enabling the user to navigate, amongst other functions of this multiplatform device, through the various functions of a virtual identity application implemented thereon. For example, the virtual identity 204, depicted here as an animated chick, is presented graphically to the user and may, depending on different identity traits and attributes, be graphically altered to reflect such traits and attributes (e.g., different facial expressions, clothing, accessories, animations, etc.). The user interface also includes a series of tabs 205: Stats (206)—which provides access to the virtual identity's variable location-sensitive attributes; Check In (208)—which allows the user to “check in” at a given location recognized by the system; Friends (210)—which lists a number of “friends” associated with the user and/or virtual identity (e.g., such as social network friends or connections, etc.); Inventory (214)—which lists different virtual items or possessions associated with the virtual identity; and Settings (216)—to adjust various operational settings of the virtual identity system or device.

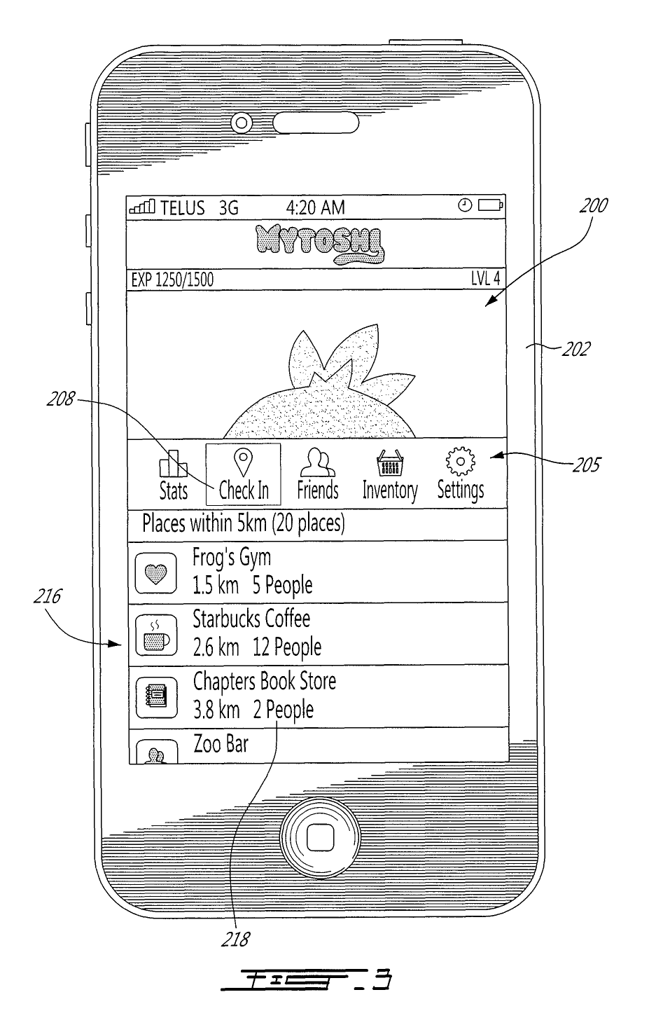

Upon selecting a given tab 205, the user navigates to a corresponding screen or wipe up tray which provides additional options. For example, and with reference to FIG. 3, selection of the Check In tab 208 automatically lists a series of recognizable locations 216 near the user, for example, as identified as a function of the user's current location obtained via the iPhone's integrated GPS receiver. In this embodiment, with each location is also identified a number of people 218 at this location either associated with the user or virtual identity (e.g., network friends or contacts), or registered with virtual identity system. For example, the system may be configured to allow cross-referencing of social network contacts with the virtual identity platform such that a user's friends also registered with the virtual identity system may be located and identified to the user. For instance, the cross-referencing of location-based social network systems such as Foursquare with the user database of the herein-described virtual identity system may allow for such streamlined integration of user contact location functions within the context of the location-sensitive virtual identity system described herein. Accordingly, the location-sensitive attribute adjustments associated with a given location may be further enhanced or modified as a function of the presence of one or more contacts at this location, thereby further increasing the complexity of location-sensitive attribute adjustments that can be implemented with the herein-described system and thereby increase the entertainment or interest value thereof.

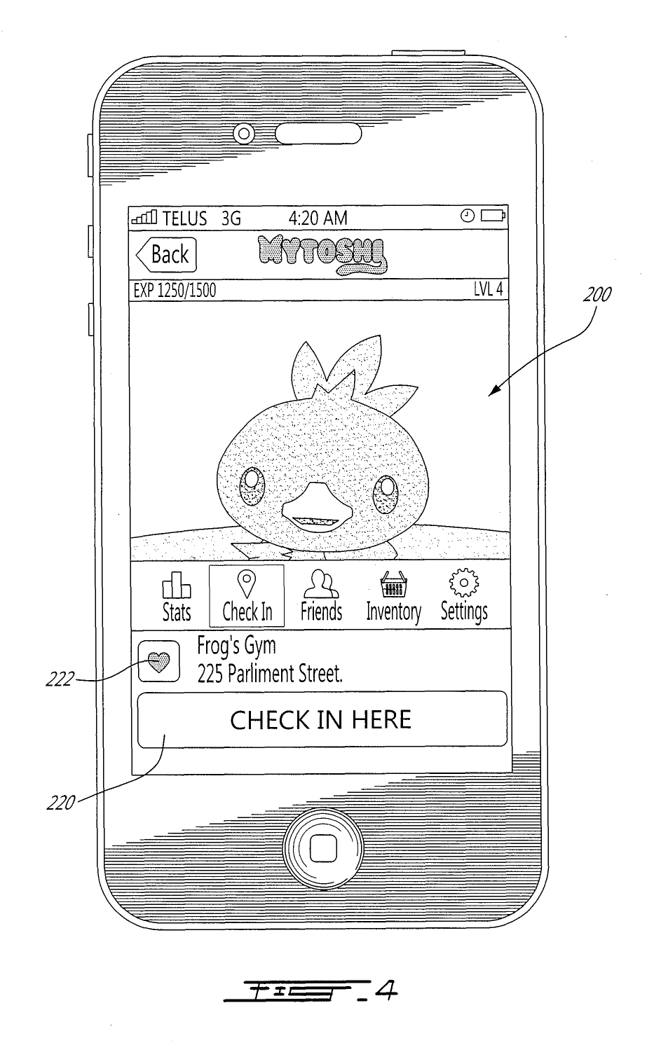

Upon selecting a location from the list, the user is provided with the option, as shown in FIG. 4, to “Check In” at this location (e.g., via virtual button 220), thereby confirming the user's frequentation of the selected establishment, venue or activity, in this case identified as Frog's Gym. Upon the user checking in, location-sensitive attribute adjustments associated with this location are automatically applied to the user's virtual identity attributes, which in this example, represent an increase in health, as graphically represented by the heart-shaped icon 222 listed against the location's name.

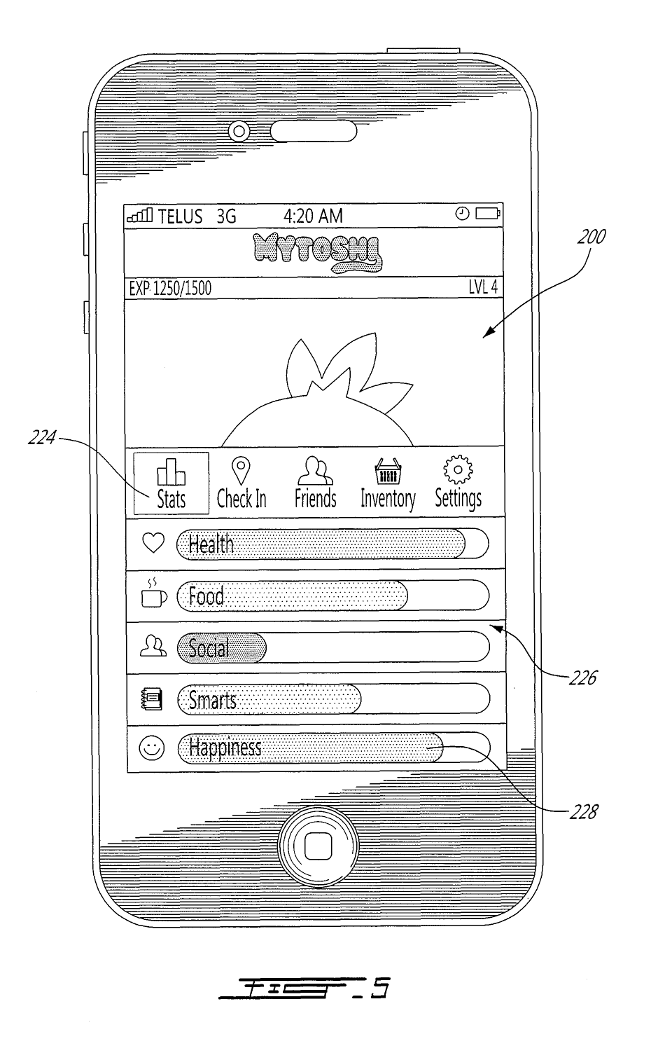

At any time, the user may consult the virtual identity's attributes by selecting the “Stats” tab 224, as shown in FIG. 5, which graphically depicts the status 226 of each variable location-sensitive attribute both by the length of an attribute fill line 228 and its associated color (e.g., red depicting a deficient attribute, yellow depicting a reasonably satisfied attribute and green depicting a good attribute, for example).

It will be appreciated by the person of ordinary skill in the art that the above provides only one example of possible system implementations, and that similar or different embodiments may be readily defined for implementation on other smartphone platforms, such as the BlackBerry or Android, or other device types, such as a laptop, netbook, cellular phone and combinations thereof, to name a few. Furthermore, while the above provides one example of a graphically rendered virtual identity interface, other embodiments may include more or less functions and complexities to achieve similar results, and that, without departing from the general scope and nature of the present disclosure. Also, while the above example contemplates the provision of a check-in option to validate and confirm a user's location, alternative embodiments, or again alternative settings for a same or similar embodiment, may enable automatic location identification and/or recognition thus reducing requirements for user interactivity while possibly increasing authenticity of the actions/inactions associated with the virtual identity (e.g., a user must actually frequent a given location to record associated attribute adjustments as opposed to potentially check-in to a location not actually frequented).

### Example 3

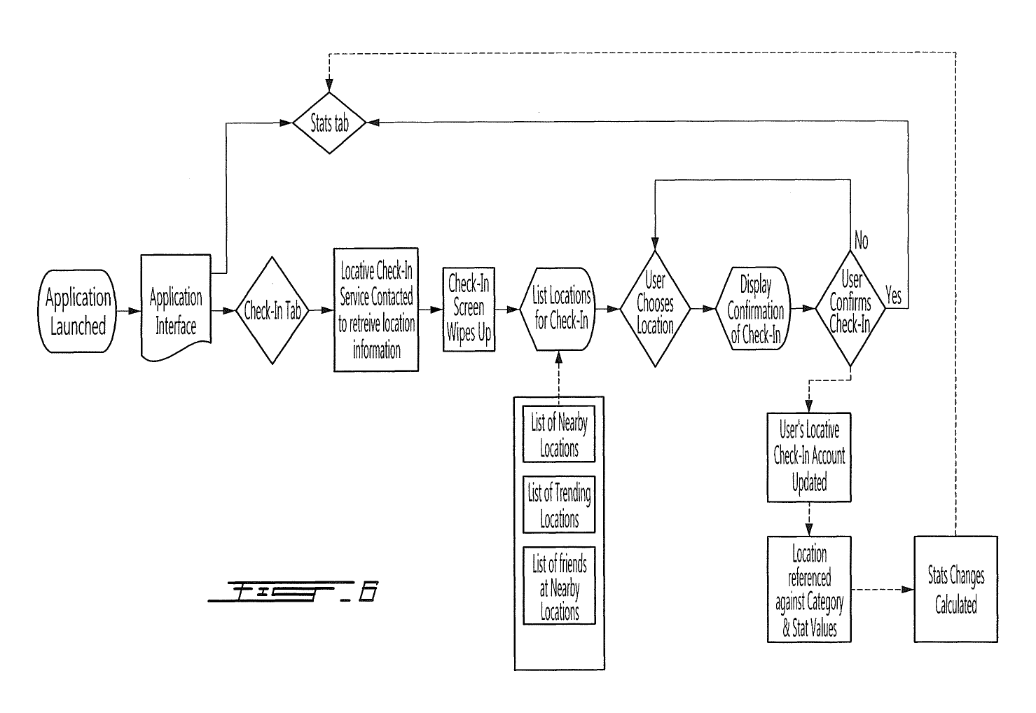

FIG. 6 provides an exemplary flow diagram of a location “Check In” process by which the user of a portable computing device implementing a virtual identity having location-sensitive attributes, as described herein and in accordance with an exemplary embodiment of the invention, can confirm frequentation of a given location thereby allowing attribute adjustments associated with this location to be affected in respect of the virtual identity.

In this example, the application is launched (either selectively or automatically upon device activation) and a virtual identity application interface is activated and/or rendered available via one or more of a minimized screen, icon, tray or the like. In this particular example, the application interface provides two options: a Stats Tab, which gives the user access to the location-sensitive attributes associated with the virtual identity, optionally amongst other identity related statistics such as identity traits, location insensitive attributes, etc.; and a Check-In tab, which allows the user to check-in one or more system recognizable locations identified as a function of location data provided by or in relation to the portable computing device (e.g., GPS, cellular triangulation, Wi-Fi, Point of Sale bar code reading, etc.).

Upon selecting the Check-In tab, a locative check-in service is automatically contacted to retrieve location information relevant to the user's current location. For example, the user's current location may be communicated to the locative check-in service server or the like, which then cross-references the current location data provided by the user's portable computing device with a database of recognizable locations to identify those in the area of the user (e.g., within a reasonable or predefined user location radius). Concurrently, a check-in screen wipes up on the user's computing device and lists available locations for check-in (e.g., the list may include, but is not limited to a list of nearby locations, a list of trending locations and/or a list/number of friends/contacts at nearby locations). From this list, the user may choose a location, in response to which a check-in confirmation may be displayed. Upon confirmed check-in, the user's locative check-in account is updated with the system. In doing so, the selected location is referenced against a predefined list or database of location-sensitive attribute adjustments, which for example, categorizes each recognizable location by type with which are associated predefined location-type specific attribute adjustments, to calculate appropriate location-sensitive attribute adjustments to be applied to the user's virtual identity attributes. The calculated adjustments are applied to the user's virtual identity and the user's application interface is guided to the stats tab where updated attributes can be viewed.

### Example 4

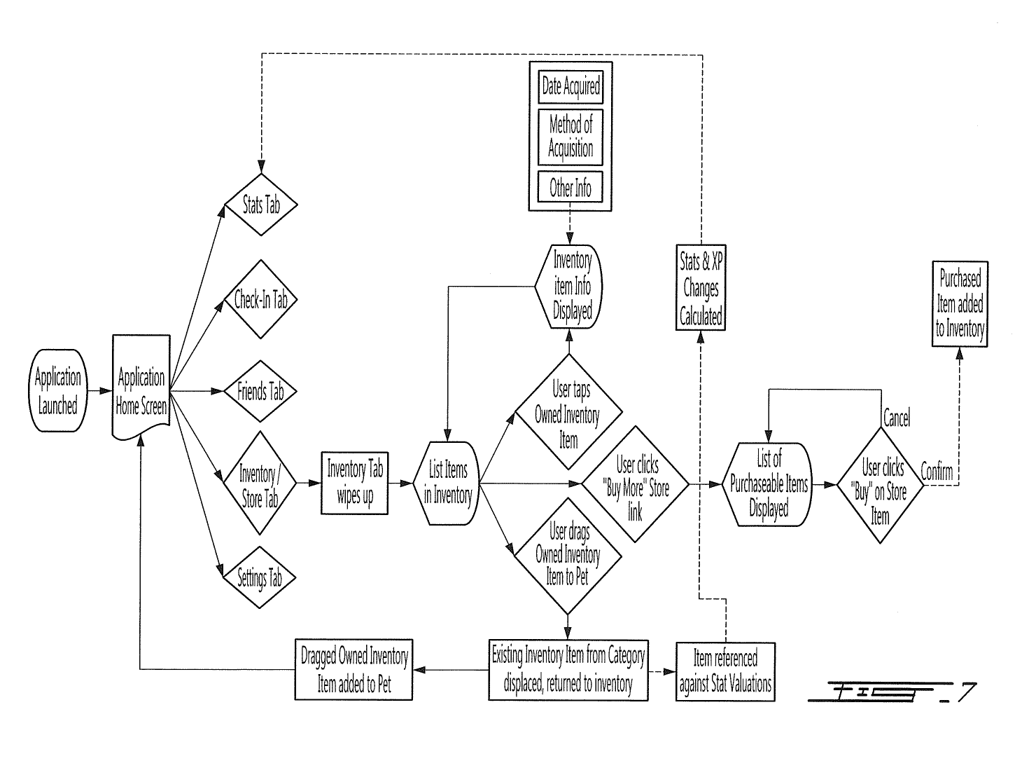

FIG. 7 provides an exemplary flow diagram of an application “Inventory/Store” process by which the user of a portable computing device implementing a virtual identity having location-sensitive attributes, as described herein and in accordance with an exemplary embodiment of the invention, can acquire and manage a virtual inventory via the portable computing device, which inventory can be applied against the virtual identity in affecting the virtual identities attributes, for example, based on various characteristics of the applied inventory.

### Example 5

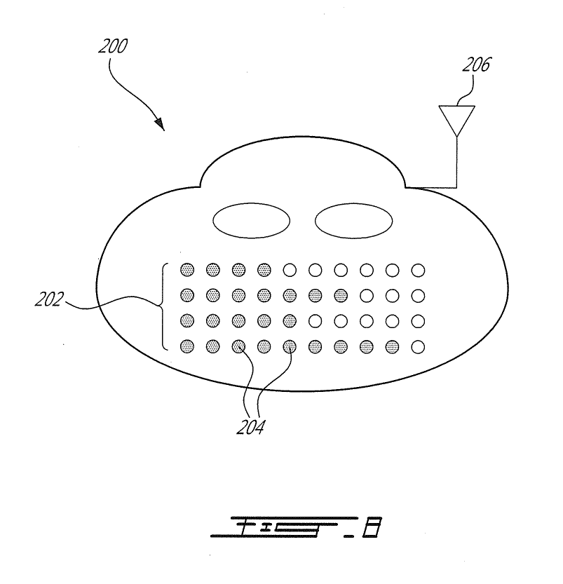

FIG. 8 provides a schematic diagram of an exemplary dedicated location-sensitive virtual identity device, in accordance with one embodiment of the invention. In this example, the device 200 comprises four (4) sets 202 of location-sensitive attribute indicators 204, for example, four distinct line formations of independent lights (e.g., LEDs) that are successively lit or extinguished responsive to the corresponding location-sensitive attribute increasing or decreasing. The device 200 further comprises a communication device, depicted illustratively herein as an external antenna 206, to allow the device to communicate wirelessly with other devices and/or system servers or the like. For example, the communication device may include a GPS receiver to enable the device 200 to self-locate, a cellular transceiver to allow the device to communicate via a cellular network, a Wi-Fi transceiver, and/or a combination thereof, to name a few. Such communication capabilities may allow the device to communicate device location to a location identification module, locative service provider and/or system control module for location identification, recognition and/or validation, and receive therefrom location-sensitive attribute adjustments, to be manifested via the indicators 204.

### Example 6

In accordance with another embodiment of the invention, the virtual identity is manifested by a virtual flower or plant, the general wellbeing and/or growth of which being at least partially affected by the user's activities. For example, the virtual plant or flower may be implemented on or by the user's portable communication device such that, upon the user frequenting various recognizable locations (i.e., identified automatically and/or via a user-actuated check-in process, as discussed above), one or more location-sensitive attribute adjustments may be accessed by the user's portable device (i.e., from a locally stored database and/or via a remote network-accessible database) to adjust respective attributes of the virtual flower or plant. Alternatively, the virtual plant or flower may be implemented on or by another of the user's computing devices, or again maintained on a system server or the like for remote access by the user, whereby a user's identified location may be identified via a distinct portable communication device and used by the system to remotely implement one or more location-sensitive attribute adjustments to the virtual identity. For example, in such embodiments, the user's identified location may either be communicated to a system server, which identifies a relevant attribute adjustment and implements such adjustment in respect of the a server-based identity for consumption upon the user later logging-in to the system's server, or again automatically communicates this adjustment to the user's other computing device, for immediate consumption or again upon the user actively retrieving and/or logging-into the system's server, for example. These and other such permutations are intended to fall within the general scope of this example, and disclosure as a whole.

In some embodiments, the user's identified locations may affect various attributes of the flower or plant, such as, but not limited to, growth, development, colour, vibrancy, health and the like. In one such example, when a user checks in to a recognizable café or grocery store, the virtual plant or flower automatically receives nourishment and/or water which allow the virtual plant to grow. Similarly, where a user generally frequents the same or same type of establishments, the plant or flower may grow relatively linearly, whereas where a user frequents a variety of establishments, the plant may grow in a more unpredictable or diversified fashion.

In some embodiments, different activities may affect the overall health of the virtual flower; for example, green activities, exercise, etc. may result in a relatively healthier plant and/or more vibrant flower or bloom, whereas unhealthy activities, such as frequenting fast-food restaurants, bars, etc. may move the virtual plant wilt.

These and other such examples will be readily apparent to the person of ordinary skill in the art to fall within the context of the present disclosure.

### Example 7

In one embodiment, the virtual identity is manifested by a colour-coded identity, such as those commonly associated with “mood rings” and like items. In such embodiment, the user's identified locations can be used and associated with predefined attribute adjustments manifested by a change in the colour-coded identity's overall colour. For example, in one embodiment, the total sum of a user's check-ins and real world actions could be displayed in a range of colours, much like a physical mood ring. These colours could come with a legend which would identify to the user how their overall behavior, as at least partially ascertained by the locations they frequent, may be qualified on a predefined overall health or personal balance scale. Observation of these attribute adjustments by way of the virtual identity's “mood” or colour could be used by the user to modify real-world actions, behaviours and/or activities in seeking to improve or achieve a desired virtual identity rating, for example.

### Example 8

In one embodiment, the user's virtual identity may be manifested by a character, community, civilization and/or other such virtual entity defined within the context of a role playing game (RPG), or the like. For example, a user's real-world activities, as identified by recognizable locations frequented by the user, may be used to implement one or more attribute adjustments related to this user's RPG character, etc. For example, the user's check-ins or otherwise identified locations or activities may be used by a system implemented RPG, for example, to implement various “power-ups” or the like that would aid the user in building their character, army and/or civilization, for example.

For example, checking into or being identified as frequenting a food-related establishment (grocery stores, restaurants, cafes, etc.) could automatically affect the user's RPG character's health, or again increase the user's virtual army's rations, etc.

Similarly, checking into or being identified as frequenting a library or school could increase the user's technology or knowledge points, which they could use towards creating new devices and/or inventions, for example.

Similarly, checking into or being identified as frequenting museums, art galleries, etc., could increase the RPG character's/army's/civilization's culture score, for example.

Similarly, checking into or being identified as frequenting a gym could increase the RPG character's strength, or the RPG army's training score and/or create more soldiers, for example.

Similarly, checking into or being identified as frequenting a park could increase their natural resources, for example.

Other such examples will be readily apparent to the person of ordinary skill in the art, and are thus intended to fall within the general scope and nature of the present disclosure.

### Example 9

In another embodiment, the virtual identity is implemented by a physical device configured to receive location-sensitive attribute adjustments directly from the user's communication device and/or from a system server, whereby a user's recognized locations are used to affect a wellbeing or condition of the physical device. In one example, the virtual identity may be manifested by or on a robot or the like, who could develop behaviours that reflect the user's real world behaviours, as interpreted by the recognizable locations frequented by the user. Similar to the virtual identities described above, the physical device may be programmed to get “sick” if the user is identified by the locations it frequents to live an unhealthy lifestyle, for example. Similarly, the physical device may act “lonely” if the user is not sufficiently identified by the location-sensitive system to partake in or attend social activities or venues, for example.

Similar to the above-described examples, the virtual identity could be managed and implemented in digital form, for example, by a digital operating system operating on the physical device and in operative communication with a system server and/or a user's networked and/or portable communication device. This physical embodiment, however, could also comprise a tangible physical form allowing for enhanced user interaction and consumption.

Similar embodiments may include, but are not limited to, a physical artificial plant that grows and prospers as a function of the user's recognizable location-sensitive activities (e.g., as described above in the context of a virtual plant or flower), a wearable physical object that changes shape and/or morphs according to the user's real-world behavior, like a medallion or bracelet, and other such devices, as would be readily appreciated by the skilled artisan.

While the present disclosure describes various exemplary embodiments, the disclosure is not so limited. To the contrary, the disclosure is intended to cover various modifications and equivalent arrangements included within the spirit and scope of the appended claims. The scope of the following claims is to be accorded the broadest interpretation so as to encompass all such modifications and equivalent structures and functions.

1. A method for adjusting one or more attributes of a virtual identity associated with a user of a portable computing device, the method comprising:
successively identifying portable computing device locations;
accessing a respective location-sensitive attribute adjustment for each of said successively identified locations; and
successively adjusting the one or more attributes as a function of each said respective location-sensitive attribute adjustment.

2. The method of claim 1, wherein the virtual identity is associated with a user of the computing device, the one or more attributes being virtually representative of recognized user activities.

3. The method of claim 2, the virtual identity being implemented within the context of a social network of such virtual identities respectively maintained by distinct users of the social network, further comprising the step of sharing said adjusted one or more attributes with at least another one of said distinct users.

4. The method of claim 2, the virtual identity being implemented within the context of a social network of such virtual identities respectively maintained by distinct users of the social network.

5. The method of claim 1, said accessing step comprising the step of accessing a recognizable establishment, activity or event associated with at least one of said locations, with which is associated said respective location-sensitive attribute adjustment.

6. The method of claim 5, wherein said recognizable establishment comprises at least one of a food service establishment, an exercise establishment, an entertainment establishment, a religious establishment and an educational establishment.

7. The method of claim 1, wherein at least one of the attributes is defined on a variable attribute value scale, a given location-sensitive attribute adjustment associated therewith being defined by an attribute value increase or decrease on said variable attribute value scale.

8. The method of claim 1, wherein at least said accessing and said adjusting steps are automatically implemented by a processor of the portable computing device and/or of one or more networked computing devices communicatively linked thereto.

9. The method of claim 1, wherein the one or more attributes are maintained by a server in a dynamic user profile, the portable computing device locations being communicated to the server, and the server accessing said respective location-sensitive attribute adjustments from a database accessible thereto, and adjusting the one or more attributes as a function thereof.

10. The method of claim 9, the virtual identity rendered on the user's portable computing device, the method further comprising the server automatically communicating the adjusted attributes to the portable computing device in rendering the virtual identity.

11. The method of claim 9, the virtual identity rendered on a distinct user device having communicative access to the server, the method further comprising the distinct user device accessing the adjusted attributes from the server in rendering the virtual identity.

12. A method for dynamically adjusting attributes of a virtual identity associated with a user of a portable computing device, the method comprising the steps of:
identifying a location of the portable computing device by location type;
accessing one or more location-sensitive attribute adjustments associated with said location type; and
adjusting the attributes as a function of said one or more location-sensitive attribute adjustments.

13. The method of claim 12, the virtual identity implemented on the portable computing device, wherein said accessing step comprises the portable computing device accessing at least one of locally stored location-type specific attribute adjustments and remotely stored location-type specific attribute adjustments.

14. The method of claim 12, the attributes remotely maintained by a server in a dynamic user profile, the location or location type being communicated to the server which accesses the one or more location-sensitive attribute adjustments from a database accessible thereto and adjusts the user profile as a function thereof.

15. The method of claim 12, said location type being defined as a function of a recognizable establishment at said location comprising at least one of a food service establishment, an exercise establishment, an entertainment establishment, a religious establishment and an educational establishment, or a recognizable activity or event taking place at said location.

16. The method of claim 12, wherein at least said accessing and said adjusting steps are automatically implemented by a processor of the portable computing device and/or of one or more networked computing devices communicatively linked thereto.

17. A computer-readable medium having statements and instructions stored thereon for implementation by a processor to dynamically adjust one or more attributes of a virtual identity implemented on the portable computing device by implementing the steps of the method as defined in claim 14.

18. A system for managing location-sensitive attributes associated with a virtual identity implemented on or associated with a user's portable computing device, the system comprising:
a data storage device for storing predefined location-sensitive attribute adjustments in association with predefined locations and/or location types;
a network communication device communicatively linkable to the user's portable computing device to access successive locations of the user's portable computing device, and operatively coupled to said data storage device to access respective location-sensitive attribute adjustments corresponding to each of said successive locations, and/or a location type thereof, and affect corresponding adjustments to the location-sensitive attributes of the virtual identity.

19. The system of claim 18, said network communication device being further communicatively linkable to one or more locative service servers and configured to communicate said location thereto to access said location type therefrom.

20. The system of claim 18, the virtual identity implemented on the user's portable computing device, said data storage device further comprising dynamic storage of the attributes to be accessed therefrom by the user's portable computing device via said network communication device.

21. The system of claim 18, the virtual identity implemented on the user's portable computing device, said communication device further configured to communicate said attribute adjustments to the user's portable computing device to affect said corresponding adjustments to the attributes of the virtual identity locally.

22. The system of claim 18, the virtual identity implemented on a distinct user device having communicative access to said communication device for accessing one of a dynamic storage of the adjusted attributes to be rendered by the virtual identity, and said attribute adjustments to affect said corresponding adjustments to the attributes of the virtual identity locally.

23. The method of claim 1, the virtual identity selected from the group consisting of a digitally rendered virtual pet, virtual plant, virtual flower, virtual entity in a role playing game, and an avatar, or implemented and manifested by a physical device selected from a robot, an artificial flower, an artificial plant and a wearable accessory.
